(19) United States
(12) Patent Application Publication
(10) Pub. No.: US 2017/0239587 A1
(43) Pub. Date: Aug. 24, 2017

(54) CONSTRUCTION UNIT

(71) Applicant: Sven Kristian Frederick ERICKSEN, Wellington (NZ)

(72) Inventor: Sven Kristian Frederick ERICKSEN, Wellington (NZ)

(21) Appl. No.: 15/513,392

(22) PCT Filed: Sep. 22, 2015
(86) PCT No.: PCT/NZ2015/050159

§ 371 Date: Mar. 22, 2017

(30) Foreign Application Priority Data
Sep. 23, 2014 (NZ) 700300

(51) Int. Cl. A63H 33/08; A63F 9/12

(52) U.S. Cl. CPC A63H 33/084; A63F 9/12; A63F 2009/1216; F21V 1/12

(57) ABSTRACT

The invention relates to a construction unit configured to interlock with other construction units to create a variety of different shapes.

### FIELD OF THE INVENTION

The invention relates to a construction unit configured to interlock with other construction units to form a variety of different three-dimensional shapes.

### BACKGROUND OF THE INVENTION

It is known to use interlocking construction units as toys, to make lampshades of various forms, wall dividers, screens, and decorations. Typically, the construction units are two-dimensional and each construction unit may comprise a series of slots for engaging with another construction unit.

Some known interlocking construction units comprise tabs at various locations for interlocking with parts of other construction units to form a three-dimensional shape, such as a lampshade. For example, it is known to construct lampshades from construction units of a substantially triangular shape having two “outwards” facing tabs or “bubbles” along each side at either end and one “concave” tab or an “indentation” in the middle of each side. These shapes are configured to only interlock with themselves to form a limited variety of geometric shapes.

Another example of a similar product is the IQ Light System, which includes a lampshade that was designed in 1972 by Danish designer Holger Strom. This lampshade is made using construction units having a substantially rhomboid shape. The geometry is known as a rhombic polyhedral. Each construction unit in the IQ Light System comprises hooks within to interlock with adjacent construction units of the same type. The IQ Light System requires a fully enclosed topology for the lamp to achieve structural stability. Again, the construction units of the IQ Light System are configured to only interlock with themselves in order to form a variety of geometric shapes.

U.S. design patent U.S. D457,833 discloses a puzzle kit capable of three-dimensional construction, such as a toy construction. The construction units in the puzzle kit are substantially polyhedral in shape and have straight lines along each edge of the polyhedral. The construction units are formed from a resiliently flexible sheet of plastics material and comprise a plurality of tabs and slots for interlocking with other construction units of the same form. However, again, only predetermined polyhedral shapes can be constructed or formed from this puzzle kit. Therefore, like the prior art described above, the kit does not provide for freeform shapes to be made.

U.S. Pat. No. 4,055,019 discloses a toy formed from construction units that may be connected together to form a polyhedron. The construction units are made out of rigid plastic (ABS) and each construction unit comprises a recessed hinge socket formed with a protruding hinge pip. The hinge pip of each construction unit is configured to fit into the hinge socket of another construction unit of the same form.

Finally, U.S. Pat. No. 4,874,341 discloses a folding polygonal toy construction unit having at least one line of reduced thickness extending across each construction unit and between at least two apices of the polygon to form a hinge, which separates the construction unit into at least two face portions (joined by the hinge) and at least one edge face. The construction units are rigid and comprise a thinned section that allows each construction unit to flex.

It is an object of the invention to provide a construction unit that may be used to create a variety of different shapes or that at least provides the public with a useful alternative to known construction units.

### SUMMARY OF THE INVENTION

The invention may provide a system of interlocking two-dimensional shapes that allows creation of two and three dimensional designs made from the shapes and in which the designs created may be Platonic solids, Archimedean solids or free-form forms.

In a first aspect, the invention provides a construction unit comprising a body having a first edge and a second edge, and further comprising two or more tabs projecting from each of the first and second edges of the body, wherein a gap is provided between adjacent tabs along the respective first or second edge, wherein an angle of less than 90° is formed between at least one of the tabs and the edge of the body in an adjacent gap, and wherein one or more of the tabs on the first edge of the body are located to substantially oppose one or more of the tabs on the second edge of the body.

Preferably, the body also comprises a first end and a second end and wherein at least one tab extends from: the first end; or the second end; or both the first and second ends.

Preferably, the unit is substantially two-dimensional.

Optionally, the edge of the construction unit provided within the gap between adjacent tabs is substantially curved. The curved edge may curve outwardly from the body. In another form, the substantially curved edge curves inwardly. Alternatively, the edge provided within the gap may be substantially straight.

Optionally, the tabs are substantially circular. In another form, the tabs may be substantially angular. In yet another form, the tabs may be irregularly shaped.

In a second aspect the invention provides, a construction unit comprising a body comprising three or more spaced apart tab arrangements, each tab arrangement comprising a pair of tabs projecting from an edge of the body, wherein each pair of tabs comprises a first substantially circular tab and a second substantially circular tab, wherein the first and second tabs lie adjacent to one another and meet an angle of less than 90°. Preferably, a wherein a gap is provided along the edge of the body between tab arrangements.

In one form, the second tab comprises an outwardly curved extension member that extends between a portion of the second tab and the body.

In one form, one or more tabs project from the edge of the body between tab arrangements and wherein a gap is provided between adjacent tabs and tab arrangements.

In one form, the construction unit comprises a substantially angular body and a tab arrangement is provided at one or more corners of the construction unit.

Preferably, the construction unit is substantially two-dimensional.

Preferably, the construction unit is configured to interlock with the construction unit of the first aspect of the invention.

In one form, the edge of the construction unit provided within the gap between adjacent tab arrangements is substantially curved. The substantially curved edge may curve outwardly from the body. Alternatively, the substantially curved edge curves inwardly.

In another form, the edge provided within the gap may be substantially straight.

The interlocking construction units according to the present invention are typically substantially two dimensional but, in some forms, the construction units may be flexed to create three-dimensional objects.

In one form, the interlocking construction units of the invention may be considered to comprise primary tabs and secondary tabs that interlock with each other. The primary tabs are preferably obtuse.

Preferably, except for continuous forms such as circles, the at least two primary or obtuse tabs on at least two edges of the body of a construction unit of the invention flare “outwards” and two secondary tabs flare “inwards” on each side of the shape.

Preferably, the primary or obtuse tabs have a base narrower than upper sections of the tabs and the secondary tabs have a base wider than upper sections of the tabs.

The secondary tabs may be positive, neutral or negative. For example, positive secondary tabs project from the edge of the body of the construction unit. Neutral secondary tabs are substantially in the form of a straight line. Negative secondary tabs form indents into the body of the construction unit.

Preferably, the widest point of the primary tabs is greater than the widest point of the secondary tabs.

### BRIEF DESCRIPTION OF THE DRAWINGS

The invention will be described by way of example only and with reference to the accompanying drawings, in which:

FIG. 1 shows just some examples of different construction units that may be used to form a construction unit of the present invention;

FIG. 2 shows two construction units of different sizes in an interlocked arrangement;

FIG. 3 shows examples of possible tab shapes that may be used with a construction unit of the invention;

FIG. 4 shows an impression of heart shapes and the tab shapes required to form the heart effect;

FIG. 5 shows the tab shaped to form a construction units with a “pohutukawa flower” effect;

FIG. 6 shows a close up of an angle where a tab meets an edge of the body of a construction unit according to one form of the invention;

FIG. 7 shows one form of construction unit of the invention comprising a substantially rectangular body and substantially circular tabs;

FIG. 8 shows another form of construction unit, which is a longer version of the unit of FIG. 7;

FIG. 9 shows yet another form of construction unit of the invention, having a substantially rectangular shaped body and substantially circular tabs;

FIG. 10 shows another form of construction unit of the invention, having a substantially rectangular shaped body and substantially circular tabs;

FIG. 11 shows another form of construction unit of the invention, having a substantially cone shaped body and substantially circular tabs;

FIG. 12 shows another form of construction unit of the invention, having a substantially square shaped body with two substantially circular tabs projecting from each edge of the square shape;

FIG. 13 shows yet another form of construction unit of the invention, having a substantially square shaped body;

FIG. 14 shows another form of construction unit of the invention, having a substantially triangular shaped body; and

FIG. 15 shows one form of mat created by multiple constructions units of the invention joined together;

FIG. 16 shows one form of three-dimensional object created by multiple constructions units of the invention joined together;

FIG. 17 shows another form of three-dimensional object created by multiple constructions units of the invention joined together; and

FIG. 18 shows yet another form of three-dimensional object created by multiple constructions units of the invention joined together.

### DETAILED DESCRIPTION OF THE INVENTION

In one form, the invention relates to a construction unit 100 comprising a body 110 and two or more tabs 120 extending from at least one edge 111 of the body 110 (where the body is a substantially continuous shape, such as a circle) or from at least two edges 111 of the body 110 (where the body is a substantially polygonal shape).

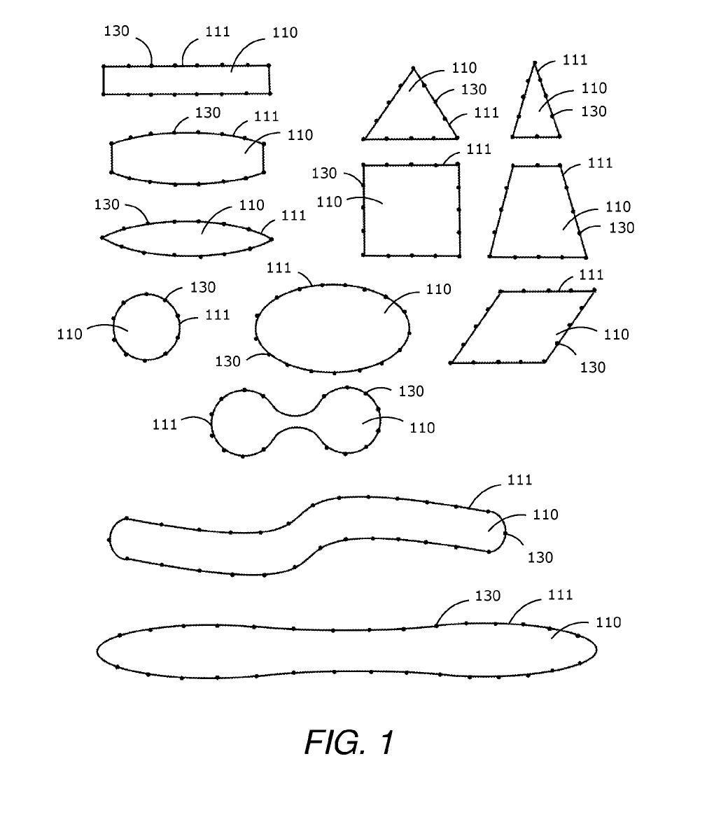

The body 110 of a construction unit 100 may be formed from any regular or irregular shape, including but not limited to: rectangles, circles, triangles, squares, pentagons, trapezoids, and “free-form” shapes. Preferred body shapes are substantially rectangular, square, or triangular shapes. Examples of just some possible body shapes (without tabs) are shown in FIG. 1.

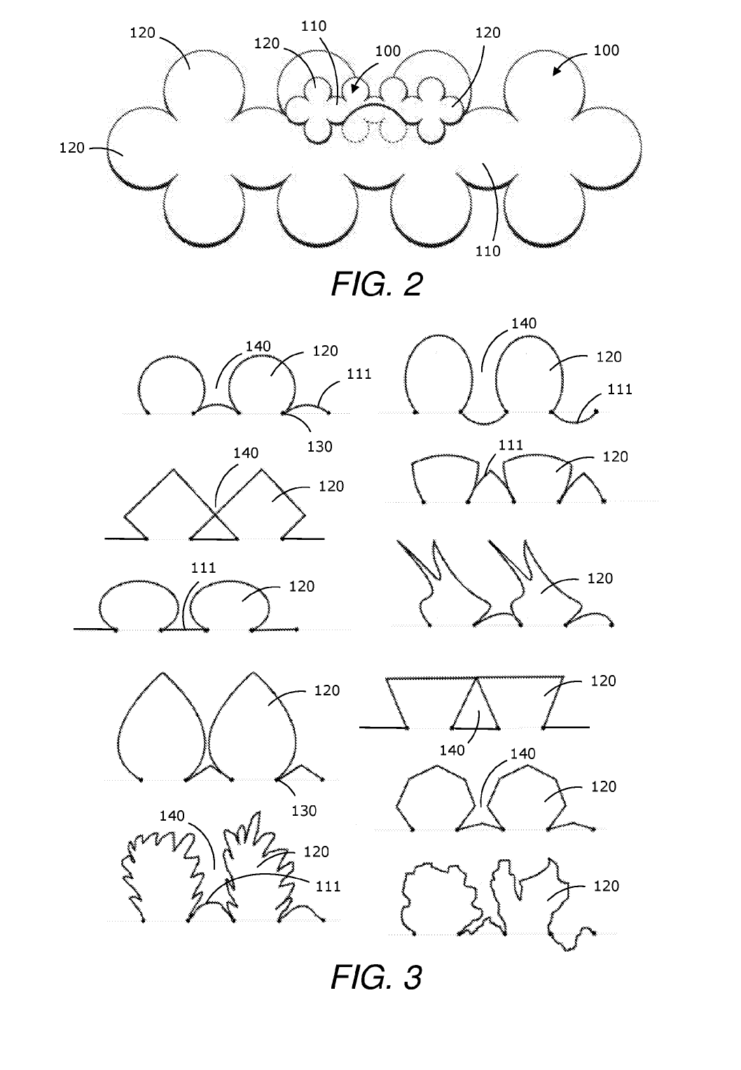

The tabs 120 are configured to project from the body 110 at spaced intervals. For example, the tabs may be configured to project from the body of the construction unit at regular intervals of between 5 mm and 500 mm. Construction units 100 can interlock with other construction units 100 having the same tab interval or with construction units where the tab intervals of the construction units differ by a 1:3 ratio, as shown by the two differently sized but interlocked construction units 100 in FIG. 2. For example, a first construction unit with a tab interval that is one third of the size of the tab interval of a second construction unit may interlock with that second construction unit. Both construction units may also interlock with a third construction unit that has a tab interval three times the size of the tab interval of the second construction unit. For example, a construction unit with a tab interval of 30 mm can interlock with construction units have tab intervals of 10 mm and 90 mm.

The dots illustrated on the edges of the body shapes in FIG. 1 illustrate intersection points 130 at which outer edges 121 of the base of each tab 120 may meet with the body 110 of the construction unit.

The tabs 120 may be attached to the body 110 but are preferably formed so as to be integral with the body. In other words, it is preferred to form each construction unit as one piece.

A gap 140 is formed between adjacent tabs that project from the body. In one form, the width of each gap 140 is substantially equal to or more than the distance between the two intersection points 130 for each tab 120.

The edge 111 of the body 110 within the gap 140 between adjacent tabs 120 may be substantially straight or shaped. For example, the edges 111 may be a curved shape. Where the edges 111 in the gap are shaped, the contours of the shaped edge 111 may substantially project outwardly from the body 110 of the construction unit or the contoured edge 111 may substantially project inwardly. Preferably, where the curved edges 111 in the gap 140 project outwardly, the widest point of the curve is less than the widest point of the tabs 120.

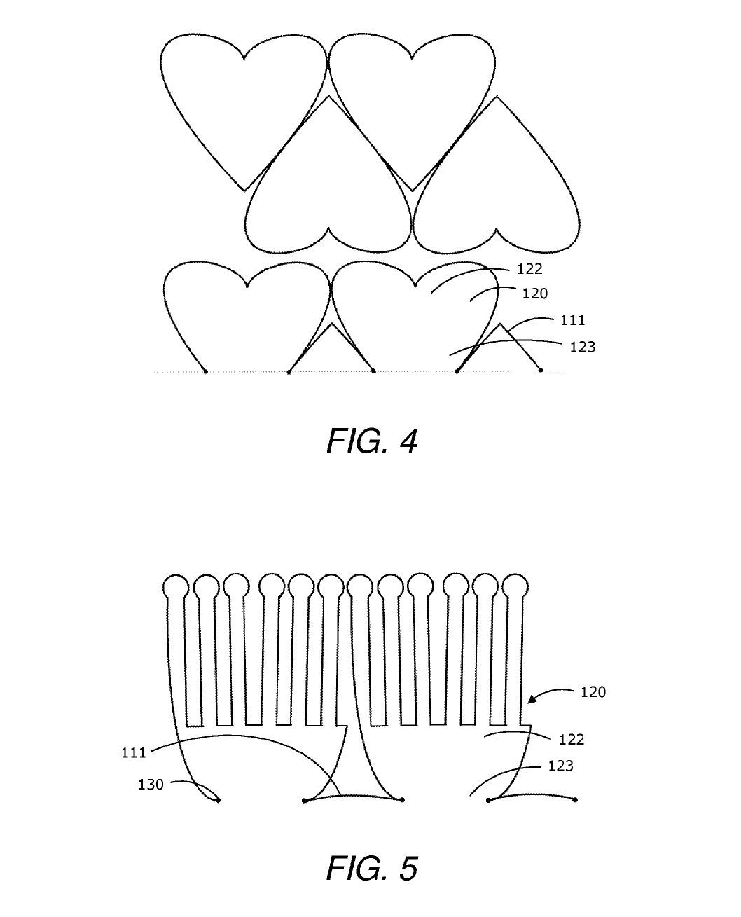

The tabs 120 that project from the body 110 of the construction unit 100 may be of any suitable regular or irregular shape. Examples of just some possible shapes of tabs are shown in FIGS. 3 to 6. The tabs 120 of a construction unit may be of the same shape or may be of different shapes. For example, a construction unit 100 may comprise one or more tabs 120 that are substantially circular and one or more other tabs 120 may be substantially triangular or diamond shaped.

Each tab 120 comprises a main body 122 and a base 123. The base 123 is provided between the main body 122 of the tab 120 and the body 110 of the construction unit 100. In effect, the base 123 is the region of the tab 120 that is at or proximate to the line between the intersection points 130 and is located between the maximum width of the tab 120 and the body 110 of the construction unit. Therefore, the smallest width of the base 123 is typically the distance between the intersection points 130 at which the tab 120 meets the body 110 of the construction unit 100.

The body 122 of the tab 120 may be of any suitable shape that comprises a maximum width that is greater than the width of the base 123 of the tab 120. For example, the tabs 120 may be substantially circular, as shown in FIGS. 8 to 14, where the maximum diameter of the circular tab 120 is provided at a substantially central region of the tab. Alternatively, the tabs 120 may be substantially fan-shaped so that the free end of each fan shaped tab forms the widest point of the tab.

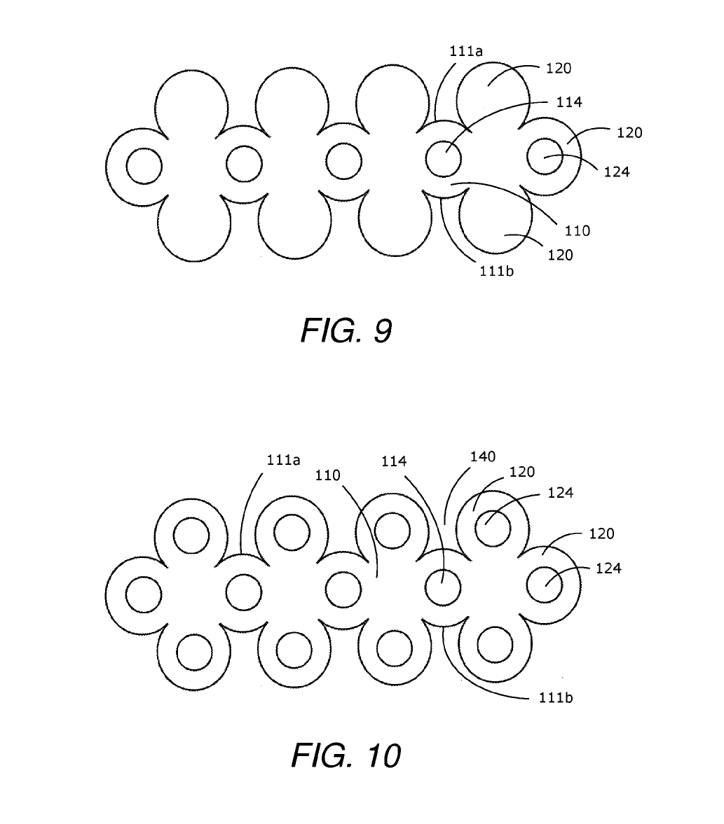

The tabs 120 may comprise cutout regions or apertures 124 for decorative or functional purposes, such as the arrangements shown in FIGS. 9 and 10. For example, in one embodiment of this invention the tabs 120 and/or body 110 of the construction unit 100 may comprise one or more openings 124, 114 that could be used to insert a light fitting into a three dimensional lampshade created from interlocked construction units 100 of the invention. The opening(s) 124, 114 would also allow heat to escape from the lampshade

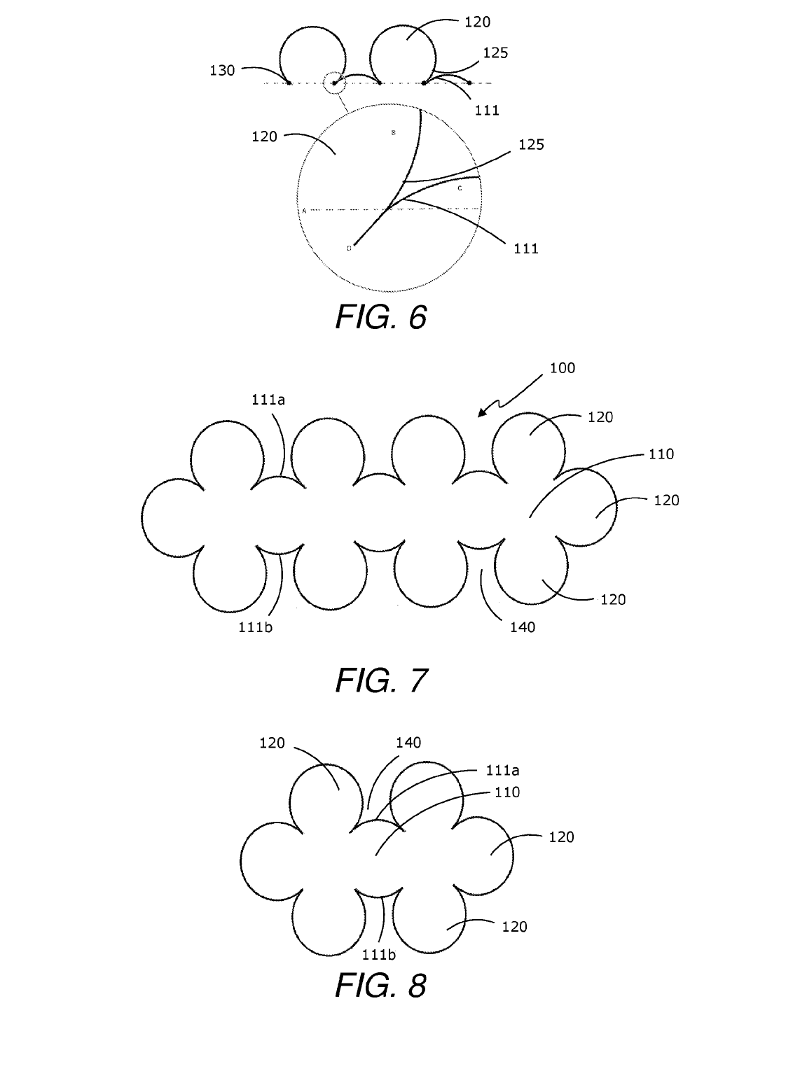

The outer edges 125 of the base 123 of the tabs 100 of the construction unit may be configured to meet the edge 111 of the body at an angle of less than 90°. The angle where outer edges 125 of the tabs meet the edge 111 of the body is referred to in this specification as the intersection angle 150. An example of an intersection angle 150 is illustrated in FIG. 6.

One form of construction unit 100, as shown in FIGS. 7 to 10, comprises a substantially rectangular body 110 having a first edge 111a, a substantially opposing second edge 111b, and two or more tabs 120 projecting from each of the first and second edges 111 of the body. The tabs 120 on each edge 111 are arranged to substantially oppose each other. A gap 140 is provided between adjacent tabs 120 along the respective first or second edge 111a, 111b. An intersection angle 150 of less than 90° is formed between at least one of the tabs 120 and the edge of the body 111 in an adjacent gap 140 so that a tab 120 of another construction unit 100 can be held within the intersection angle 150. The body 110 of the construction unit 100 also comprises a first end 115a and a second end 115b. A tab 120 may extend from the first end 115a of the body 110, the second end 115b, or both.

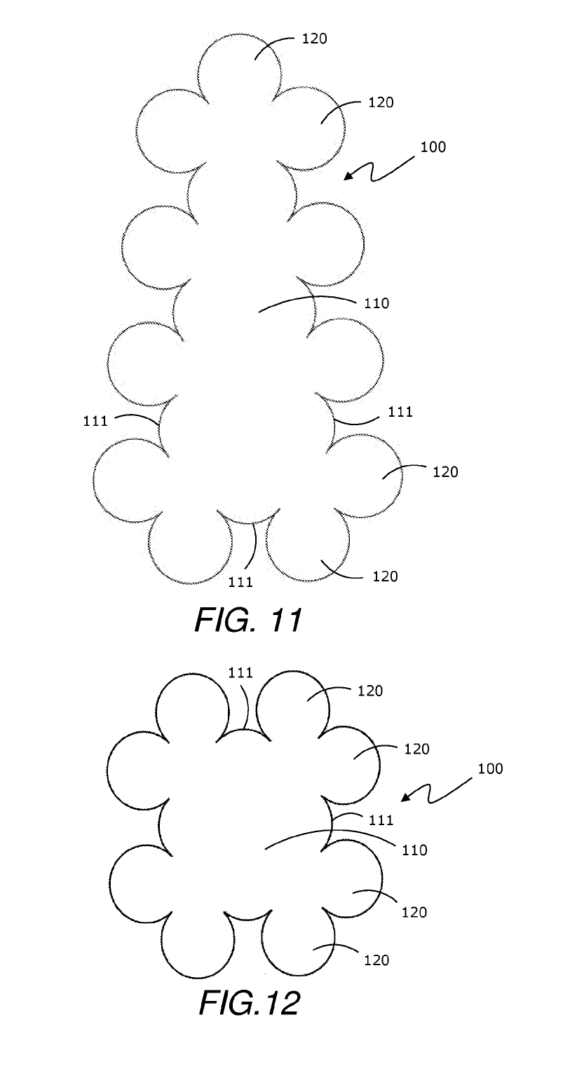

The construction unit 100 shown in FIG. 11 is similar in that it comprises tabs 120 that extend from first and second edges 111 of the body 110 in a substantially opposing arrangement. However, the construction unit 100 of FIG. 11 has a substantially cone shaped body 110.

It is possible to consider the projecting tabs 120 to be primary tabs and the edges 111 of the gap 140 between primary tabs to be secondary tabs. In one form, the construction unit may be considered to comprise at least two obtuse tabs projecting from at least two sides of each construction unit body (except for continuous construction unit body shapes, such as circles) that flare “outwards” and two acute tabs that flare “inwards” on each side of the shape. FIGS. 9 and 10 show a construction unit comprising a substantially rectangular body and four obtuse circular tabs projecting from each side and each end of the body. The obtuse tabs have other edges flaring out at an angle greater than 90 degrees relative to the centre of the tab. The acute tabs have outer edges flaring out at an angle less than 90 degrees relative to the centre of the tab. The acute angle may be positive, neutral or negative relative to the obtuse tab. The sum of the obtuse and acute angles, relative to the line of the base shape would not exceed 180 degrees where the base shape has a straight edge (unless two layers of obtuse and acute tabs are welded or joined together). Where the base shape is concave or convex in nature, the maximum sum of the angles would be the angle of incidence of the two imaginary straight lines connecting the intersection points of the two tabs. However, the closer that the obtuse and acute angles approach 90 degrees, the weaker the interlocking effect that will be achieved.

The edge of each obtuse tab and acute tab may extend a short way past the line of the base shape. The length of this extension is generally two to three times the thickness of the material and is related to the flexibility of the material that the base shape is manufactured from. The thicker the material, the larger the tab interval that will be required to achieve an interlocking effect. The greater the flexibility of the material, the shorter the extension needs to be. If the extension is relatively large for the thickness and flexibility of the material and the angle of the obtuse edge is close to 90 degrees, the interlocking effect of the tabs will be reduced.

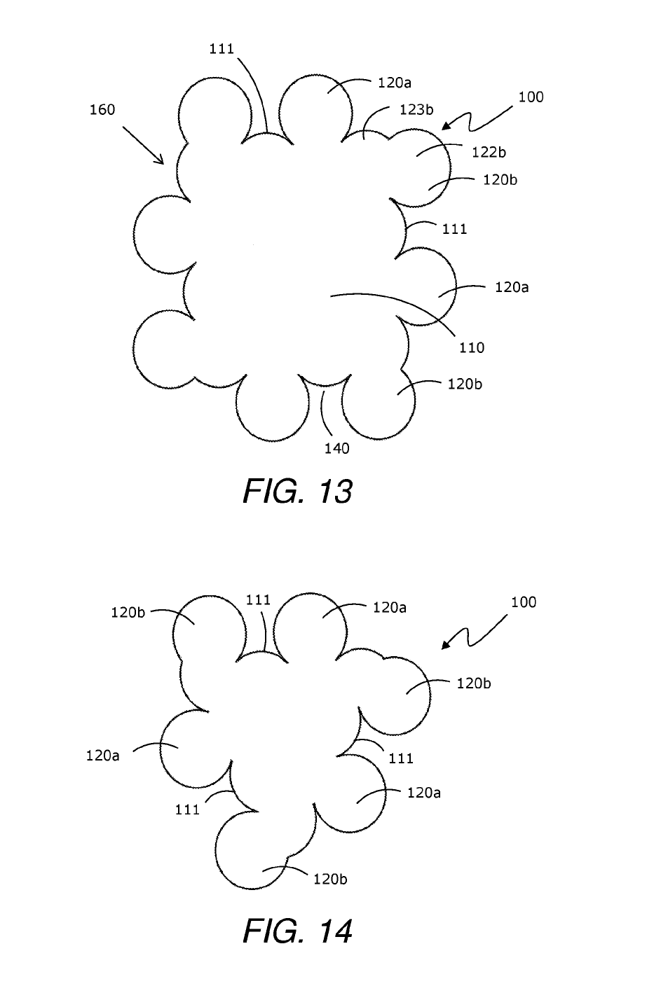

FIGS. 12 to 14 show other forms of construction units 100 according to the invention. The bodies 110 of the construction units 100 of FIGS. 12 and 13 are substantially square shaped and the body 110 of the construction unit 100 in FIG. 13 is substantially triangular. Each of these construction units 100 may be configured to interlock with each other and with other construction units 100, such as those shown in FIGS. 7 to 10.

The construction units 100 of FIGS. 12 to 14 each comprise a body 110 comprising tab arrangements 160 extending from each side edge of the body 110. The construction units 100 may comprise at least three tab arrangements 160 if the body is substantially triangular or four or more tab arrangements 160 if the body is substantially square or rectangular. Each tab arrangement 160 comprises a pair of tabs 120 projecting from a side edge 111 of the construction unit body 110. The tabs 120 may be of any suitable shape and dimension, as described above. In the form illustrated, each pair of tabs 120 comprises a first substantially circular tab 120a and a second substantially circular tab 120b. In the embodiment illustrated in FIGS. 13 and 14, the base 123b of the second tab 120b comprises an outwardly curved extension member that extends between a portion of the body 122b of the second tab 120b and the body 110 of the construction unit 100.

In each of the forms shown in FIGS. 12 to 14, the first and second tabs 120a, 120b lie adjacent to one another and meet an angle of less than 90°. A gap 140 is provided along the edge 111 of the construction unit body 110 between each tab arrangement 160. The edge 111 of the construction unit body 110 that lies within the gap 140 may be substantially straight or shaped, as described above. For example, the edge may curve outwardly or inwardly.

In one form, a construction unit may comprise three or more tab arrangements, as described above, and at least one additional tab located between adjacent tab arrangements. Also as described above, a gap is located between each tab and tab arrangement. In other words, where two tabs are adjacent each other, a gap is provided between the two tabs, and where a tab is adjacent a tab arrangement, a gap is provided between the tab and tab arrangement also. For example, a tab arrangement may be provided at or near one or more corners of an angular construction unit body and multiple spaced apart tabs may project from the edge of the body between the tab arrangements. Edges of the body within the gaps may be straight or shaped to curve outwardly from the body or inwardly into the body.

From another perspective, the construction unit comprising a substantially triangular body comprises a series of tabs that resemble bubbles. These tabs may be considered to be primary or obtuse tabs (which have a base narrower than the upper sections). The construction unit also comprises an equal number of secondary or acute tabs having a base wider than the upper sections. These secondary or acute tabs can be positive, neutral or negative. For example, positive or acute secondary tabs project from the edge of the construction unit body. Neutral tabs are substantially straight edges of the construction unit body. Negative secondary tabs form indents into the body.

The construction units 100 of the invention are configured so that the base 123 of a tab 120 of one construction unit 100 is able to be located in the gap 140 formed between adjacent tabs 120 of another construction unit 100. In effect, the two outer edges 121 of the base of a first tab 120 of a first construction unit are held within the two intersection angles 150 formed by adjacent first and second tabs 120a, 120b of a second construction unit 100 and the edge 111 of the body 110 of the second construction unit 100. The smaller the intersection angle 150 between the edge 111 of the second construction unit 100 and the outer edges 121 of the base of each of the first and second tabs 120a, 120b of that construction unit 100, the better that the first tab 120 of the first construction unit 100 is held in place. The widened profile of each tab body 122 helps to prevent the interlocked tabs from separating from each other.

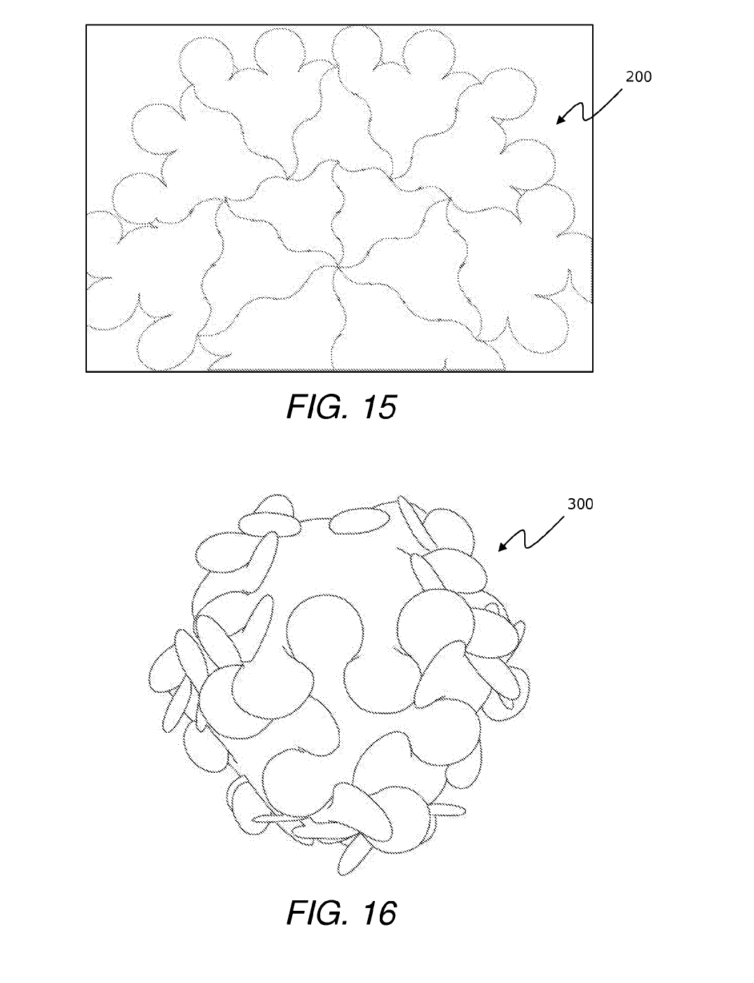

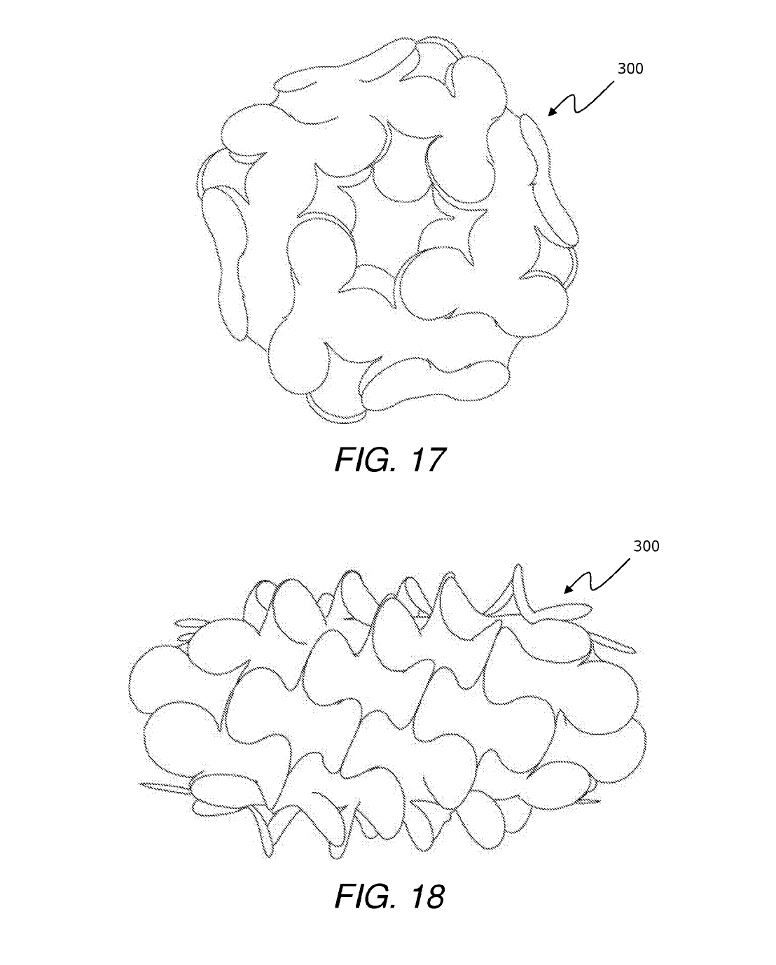

In this arrangement, a first construction unit 100 may interlock with a second construction unit 100 by weaving the tabs 120 of each construction unit 100 together so that the bases 123 of the tabs 120 of the second construction unit 100 are held between the bases 123 of adjacent tabs 120 of the first construction unit 100. As more construction units 100 are woven together, the interlocked construction units 100 form a two-dimensional mat 200, an example of which is shown in FIG. 15. The mat 200 may optionally be flexed or curved so that construction units 100 at the edges of the mat can interlock with construction units 100 at other edges of the mat 200 to form the mat into a three dimensional object 300. The construction units may be joined together into a three dimensional shape to form cylinders, spheres, dodecahedrons, and tetrahedrons for example. Further examples of just some forms of three dimensional objects 300 that can be created with the construction units 100 of the invention are shown in FIGS. 16 to 18.

By interlocking the tabs of two or more construction units, it is possible to create shapes that may provide a pleasing and novel decorative effect. In some forms, the tabs may also create a strong decorative element, as shown in FIGS. 16 to 18. For example, where interlocked construction units are curved to form a three dimensional shape 300, in some forms, the tabs may flare outwards to add texture and interest to the three dimensional shapes 300.

The construction units may be formed from a rigid, semi-rigid, or flexible material, to allow different shapes to be formed. For example, the construction units of the invention may be manufactured from a variety of suitable materials, including but not limited to the following materials: plastic, such as polypropylene; ABS (acrylonitrile-butadiene-styrene copolymer); acrylic; Perspex; PET (Polyethylene Terephthalate); PVC (un-plasticised and plasticised polyvinyl chloride); high density polyethylene; low density polyethylene; Kevlar, or polystyrene; metal, including aluminium—anodised or lacquered, stainless steel, steel—lacquered or painted, chrome, bronze or brass; wood, including bamboo veneer, other veneers or thin slices of wood; glass; rubber; leather; and felt. Preferably, the construction units are substantially two dimensional and are formed from a substantially thin material. Rigid or semi-flexible construction units typically need to be interlocked with flexible construction units to form three dimensional shapes.

The present invention also relates to a kit of parts comprising a set of construction units 100 of the invention that may be “interlocked together” to construct either a pre-determined shape or a freeform shape of one's own creation. Optionally, the kit comprises different shaped construction units 100. Three-dimensional shapes 300 can be made from construction units 100 in the kit by interlocking the construction units 100 together, as described above.

### Advantages

The construction unit and kit of the invention offer many advantages. In particular, the invention makes it possible to interlock construction units of different sizes and shapes to create a variety of different shapes, including three-dimensional shapes that may be used as toys, lampshades, acoustic structures, craft units, wall dividers, decorative elements, floor coverings, building structures such as emergency shelters, clothing and/or protective gear. The invention may also be used as a team building tool or a rehabilitation or occupational therapy tool.

Unlike known construction units, the construction units of the present invention do not need to meet at the corners when attached together to form a mat or three-dimensional shape. Because the construction units of the invention avoid this limitation, a large variety of shapes and patterns can be created with the construction units.

The construction units may be substantially two-dimensional or they may be moulded to be substantially three-dimensional or both, such as a three-dimensional body and two dimensional tabs. Again, a variety of different shapes and patterns can be created by using two and/or three-dimensional construction units.

Whilst the invention has been described with reference to the accompanying drawings and embodiments, it will be apparent from the description that a wide variety of shapes and tabs can be used and incorporated into designs according to the invention as described above.

1. A construction unit comprising a body comprising a first edge and a second edge, and further comprising two or more tabs projecting from each of the first and second edges of the body, wherein a gap is provided between adjacent tabs along the respective first or second edge, wherein an angle of less than 90° is formed between at least one of the tabs and the edge of the body in an adjacent gap, and wherein one or more of the tabs on the first edge of the body are located to substantially oppose one or more of the tabs on the second edge of the body, and wherein the edge of the construction unit provided within the gap between adjacent tabs substantially curves outwardly from the body.

2. The unit of claim 1, wherein the body also comprises a first end and a second end and wherein at least one tab extends from: the first end; or the second end; or both the first and second ends.

3. The unit of claim 1, wherein the unit is substantially two-dimensional.

4.-6. (canceled)

7. The unit of claim 1,
wherein the tabs are substantially circular.

8. A construction unit comprising a body comprising three or more spaced apart tab arrangements, each tab arrangement comprising a pair of tabs projecting from an edge of the body, wherein each pair of tabs comprises a first substantially circular tab and a second substantially circular tab, wherein an outer edge of the first tab lies adjacent an outer edge of the second tab to form an angle of less than 90° between the adjacent edges of the first and second tabs, wherein a gap is formed between adjacent pairs of tab arrangements, and wherein the edge of the body provided within the gap substantially curves outwardly from the body.

9. The construction unit of claim 8, wherein the second tab comprises an outwardly curved extension member that extends between a portion of the second tab and the body.

10. The construction unit of claim 8, wherein one or more tabs project from the edge of the body between tab arrangements and wherein a gap is provided between adjacent tabs and tab arrangements.

11. The construction unit of claim 8,
wherein the construction unit comprises a substantially angular body and a tab arrangement is provided at one or more corners of the construction unit.

12. The construction unit of claim 8,
wherein the unit is substantially two-dimensional.

13. The unit of claim 8, wherein the unit is configured to interlock with a construction unit including a body comprising a first edge and a second edge, and further comprising two or more tabs projecting from each of the first and second edges of the body, wherein a gap is provided between adjacent tabs along the respective first or second edge, wherein an angle of less than 90° is formed between at least one of the tabs and the edge of the body in an adjacent gap, and wherein one or more of the tabs on the first edge of the body are located to substantially oppose one or more of the tabs on the second edge of the body, and wherein the edge of the construction unit provided within the gap between adjacent tabs substantially curves outwardly from the body.

14.-16. (canceled)
